(19) United States
(12) Patent Application Publication
(10) Pub. No.: US 2013/0074109 A1
(43) Pub. Date: Mar. 21, 2013

(54) TELEVISION LISTING USER INTERFACE BASED ON TRENDING

(71) Applicant: Sidebar, Inc., Redondo Beach, CA (US)

(72) Inventors: Richard Skelton, Los Angeles, CA (US); Jason Rosenthal, Los Angeles, CA (US); Eric Wilson, Los Angeles, CA (US); Patrick Kennedy, Kennedy, CA (US); Stephanie L. Grossman, Santa Monica, CA (US)

(73) Assignee: Sidebar, Inc., Redondo Beach, CA (US)

(21) Appl. No.: 13/623,867

(22) Filed: Sep. 20, 2012

Related U.S. Application Data
(60) Provisional application No. 61/536,968, filed on Sep. 20, 2011.

(51) Int. Cl. H04N 21/482; H04N 21/24

(52) U.S. Cl. 725/14; 725/46

(57) ABSTRACT

Systems, methods, and media for a television listing user interface for set top boxes, computers, tablets, mobile phones, and other devices. Exemplary methods may include ranking broadcast content according to trend data and a program guide that includes a visual representation of the ranked broadcast content, which may be hierarchically ranked according to the trend data.

### CROSS-REFERENCES TO RELATED APPLICATIONS

This application claims the priority benefit of U.S. provisional patent application No. 61/536,968, filed on Sep. 20, 2011 and entitled “TV Listing User Interface Based on Trending.” This application is related to the following co-pending and commonly assigned patent applications: application Ser. No. 12/139,384 entitled “Cognitive Scheduler” filed on Jun. 13, 2008, which claims priority benefit of application Ser. No. 61/030,191 entitled “Third Party Content” filed on Feb. 20, 2008 and application Ser. No. 61/035,531 entitled “Cognitive Scheduler for Mobile Platforms” filed on Mar. 10, 2008; application Ser. No. 11/411,066 entitled “System and Method for Consumer Engagement and Revenue Optimization” filed on Apr. 25, 2006, which claims priority benefit of application Ser. No. 60/674,745 entitled “Method for Consumer Engagement and Revenue Optimization” filed on Apr. 25, 2005, application Ser. No. 60/761,840 entitled “System for Deploying Targeted Content in White Space on Wireless Devices” filed on Jan. 25, 2006, application Ser. No. 60/772,770 entitled “System for Deploying Targeted Content in White Space on Wireless Devices” filed on Feb. 13, 2006, and application Ser. No. 60/675,772 entitled “Method for Consumer Engagement and Revenue Optimization” filed on Apr. 28, 2005; application Ser. No. 12/390,310 entitled “Third Party Content Management System and Method” filed on Feb. 20, 2009 which is a continuation in part of application Ser. No. 12/139,394 entitled “Content Management System and Method” filed on Jun. 13, 2008 and application Ser. No. 12/139,384 entitled “Cognitive Scheduler” filed on Jun. 13, 2008, and application Ser. No. 11/411,066 entitled “System and Method for Consumer Engagement and Revenue Optimization” filed on Apr. 25, 2006; and application Ser. No. 12/139,394 entitled “Content Management System and Method” filed on Jun. 13, 2008 which is a continuation in part of application Ser. No. 11/411,066 entitled “System and Method for Consumer Engagement and Revenue Optimization” filed on Apr. 25, 2006. All of the aforementioned disclosures are hereby incorporated herein by reference in their entirety including all references cited therein.

### FIELD OF THE INVENTION

Systems, methods, and media are provided herein for TV listing user interfaces, such as program guides for set top boxes, computers, tablets, mobile phones and other devices. In some embodiments, broadcast content (e.g., channels and television show programming) included in exemplary user interfaces are dynamically prioritized or ranked such that the broadcast content may be displayed based on trend data.

### BACKGROUND

Currently, television (TV) listing user interfaces for set-top boxes, computers, tablets, mobile phones, and other devices typically display channels and programs (content) in a static grid list arranged by the time of day on one axis and the numerical order of channels available to a subscriber of a cable system on another other axis. Users may be able to navigate forward in time on the grid interface to see what will be shown on a certain channel or grouping of channels in the future, and they may navigate through all available channels to see what is on at any given time. Users may also manually enter in a channel number to see what is on that particular channel in the grid listing interface.

There are often hundreds or thousands of channels within a cable system for a user to choose from, and each channel may show a plurality of programs per day. The limitation of current grid-based user interfaces for televisions require that users must know what they want to watch and enter the channel number manually, use a search utility, or they must scroll through these hundreds or thousands of channels to discover the programming that they want to watch. Scrolling through all of these channels is prohibitive, frustrating, and time-consuming for the user.

### SUMMARY OF THE PRESENT TECHNOLOGY

According to some embodiments, the present technology may be directed to methods that comprise: (a) ranking, via a trend analysis system, broadcast content according to trend data; and (b) generating a program guide that includes a visual representation of the broadcast content, which is hierarchically ranked according to the trend data. The generating may be accomplished via user interface module.

According to exemplary embodiments, the present technology may be directed to systems that comprise: (a) at least one computing device comprising: a memory that includes executable instructions and a processor executing the instructions, the instructions comprising: (i) a recommendation engine that ranks broadcast content according to trend data; and (ii) a user interface module that generates a program guide that includes a visual representation of the broadcast content, which is hierarchically ranked according to the trend data.

According to some embodiments, the present technology may be directed to methods that comprise: (a) broadcasting a program guide, the program guide comprising a dynamic ordering of broadcast content based upon trend data, the trend data comprising one or more of personal trend data, social network data, content consumption data, search engine data, program viewership data, box office data, content ratings, rental data, sales data, and combinations thereof.

According to other embodiments, the present technology may be directed to a non-transitory machine-readable storage medium having embodied thereon a program. In some embodiments the program may be executed by a machine to perform a method. The method may comprise: (a) ranking, via a trend analysis system, broadcast content according to trend data; and (b) generating, via a user interface module, a program guide that includes a visual representation of the broadcast content, which is hierarchically ranked according to the trend data.

### BRIEF DESCRIPTION OF THE DRAWINGS

Certain embodiments of the present technology are illustrated by the accompanying figures. It will be understood that the figures are not necessarily to scale and that details not necessary for an understanding of the technology or that render other details difficult to perceive may be omitted. It will be understood that the technology is not necessarily limited to the particular embodiments illustrated herein.

FIG. 1 is a block diagram of an exemplary architecture in which embodiments according to the present technology may be practiced.

FIG. 2 is a graphical user interface in the form of a default trend user interface (e.g., program guide).

FIG. 3 illustrates a user selectable trend relative to the default trend user interface.

FIGS. 4A and 4B illustrate trend reprioritization across time slots of a program guide.

FIG. 5 illustrates internal search feature for a program guide.

FIG. 6 illustrates an alert message provided via a graphical user interface.

FIG. 7 illustrates an exemplary computing system that may be used to implement embodiments according to the present technology.

FIG. 8 is a flowchart of an exemplary method for generating a program guide.

### DESCRIPTION OF EXEMPLARY EMBODIMENTS

While this technology is susceptible of embodiment in many different forms, there is shown in the drawings and will herein be described in detail several specific embodiments with the understanding that the present disclosure is to be considered as an exemplification of the principles of the technology and is not intended to limit the technology to the embodiments illustrated.

The terminology used herein is for the purpose of describing particular embodiments only and is not intended to be limiting of the invention. As used herein, the singular forms “a”, “an,” and “the” are intended to include the plural forms as well, unless the context clearly indicates otherwise. It will be further understood that the terms “comprises” and/ or “comprising,” when used in this specification, specify the presence of stated features, integers, steps, operations, elements, groups, and/or components, but do not preclude the presence or addition of one or more other features, integers, steps, operations, elements, components, and/or groups thereof.

It will be understood that like or analogous elements and/or components, referred to herein, may be identified throughout the drawings with like reference characters. It will be further understood that several of the figures are merely schematic representations of the present technology. As such, some of the components may have been distorted from their actual scale for pictorial clarity.

Generally speaking, the present technology may be utilized to generate program guides or other ranked listings of broadcast content. In some instances, the program guide may be generated by ranking broadcast content according to trend data. The ranked broadcast content may be utilized to generate a program guide that includes a visual representation of the broadcast content in a hierarchical format. The program guide may be then broadcast or otherwise provided to an end user, and specifically to an end user computing device.

The term “broadcasting” may be understood as being defined broadly to encompass one or more of a plurality of processes by which a program guide may be delivered to an end user computing device. Exemplary methods may comprise broadcasting the exemplary program guides or other user interfaces over a network, such as the Internet, or may comprise broadcasting over a wireless network, such as a cellular network. Alternatively, broadcasting may comprise traditional television broadcasting methods using satellites, receivers, fiber optics, other common media for broadcasting television signals, etc.

The term “broadcast content” is also expansive, comprising any type of content that can be broadcast, including but not limited to, audio signals, video signals, multimedia signals, images, and so forth. Exemplary types of broadcast content comprise television shows, movies, streaming audio and/or video, and so forth. One of ordinary skill in the art will appreciate the vast array of broadcast content that may be provided to an end user computing system using the present technology.

Exemplary TV listing user interfaces based on trends described herein may, in some instances, comprise a program guide. The program guide may comprise a dynamically alterable display of broadcast content for any given time of day by reflecting the priority of a trend, or a number of trends, rather than remaining static in the canonical numeric order of channels and times.

The phrase “trend data” will be understood to comprise not only data relative to various broad categories such as viewership, social media, search requests/results, and so forth, as the data changes over time, but also may comprise a snapshot of data at a given point in time. For example, trend data may comprise viewership statistics for a television program over a given period of time. Alternatively, trend data may comprise an aggregate number of viewers watching a television program at a specific point in time. Within the context of social media, topics or content are considered to be “trending” based upon mentions of that topic or media over time, or at a given point in time.

As the user scrolls forward in time on the interface, the hierarchical listing of broadcast content (e.g., channels and associated programs) may change to reflect the particular trend of interest, as will be described in greater detail below.

Several exemplary embodiments of program guides that provide trend based-rankings of broadcast content are provided herein. Some exemplary embodiments allow an end user to utilize trends by selecting a particular filter. That is, the end user may select one of these filters to view listings of broadcast content based on a selected trend. Again, the selected trend may be used to selectively prioritize and/or reprioritize the broadcast content listed in the program guide.

Additional embodiments may allow for the selective ranking of broadcast channels using default types of trend data. For example, the present technology may utilize trend data such as “content ratings,” “social media trends,” “aggregate viewership trends,” “search engine trends,” and so forth. In sum, there may be many trends that can be applied as inputs to the broadcast content in generating a program guide.

By way of non-limiting example, a unifying event or significant news story that occurs may drive people to tune into broadcast content, such as live news reports. Examples of such events may be a major political announcement or the crescendo of an exciting sports event. When events such as these occur, an alert may be created by the immediate trend of increased viewership and be presented to the end user. The sending of an alert message may be triggered by aggregate viewership trend data as determined by analyzing a social graph or an aggregate of “friends” viewership (a combination of aggregate viewership and/or social media data) that are tuning into a program concurrently. Additionally, external trends such as the number of posts or mentions via a social media service such as Twitter®, or the number of searches generated by a search engine for a particular topic may also be used to create trend alerts. These and other advantages of the present technology will be discussed in greater detail herein.

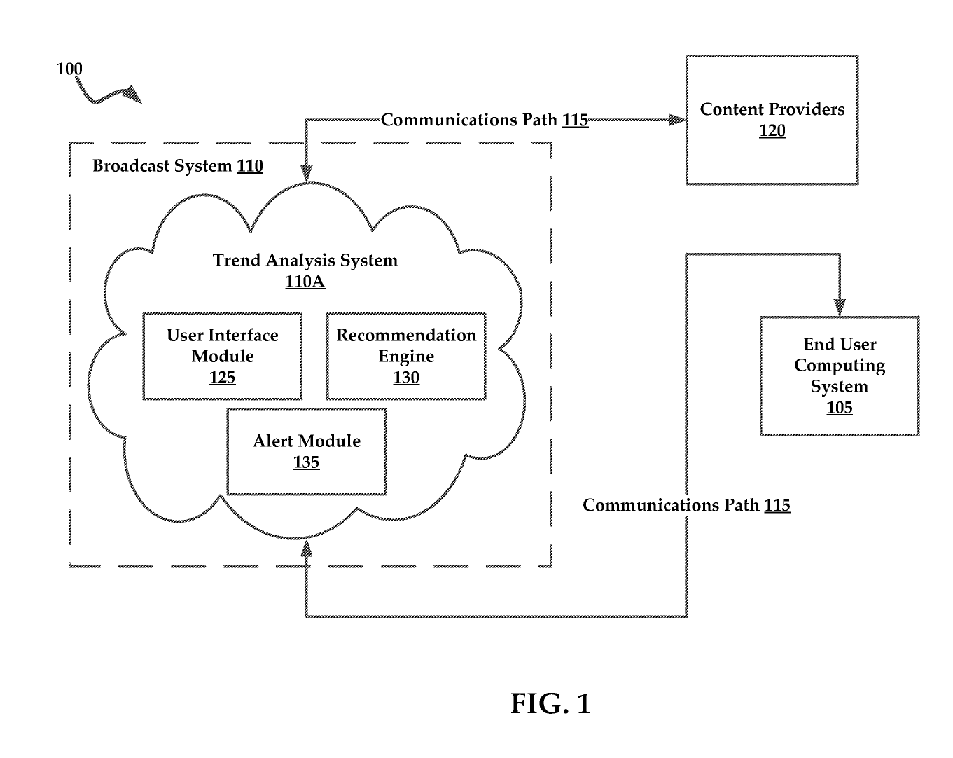

Referring now to the drawings, and more particularly to FIG. 1, a schematic diagram of an exemplary architecture 100 for practicing the present technology is depicted. Architecture 100 may include an end user computing device (or system) 105, which is communicatively coupled with a broadcast system 110 via a communications path 115. Again, the broadcast system 110 may comprise any suitable system for delivering broadcast content, keeping in mind that broadcast content may comprise any type of content that is “broadcast” over a network connection, although other traditional methods of broadcasting using satellites, antenna transmission, etc. are also likewise contemplated for use in accordance with the present technology. Thus, although the communications path 115 is shown as comprising a direct path between the end user computing device 105 and the broadcast system 110, the communications path 115 may comprise a plurality of communications paths that allow for the communication of program guide signals and/or broadcast content signals from the broadcast system 110 to the end user computing device 105.

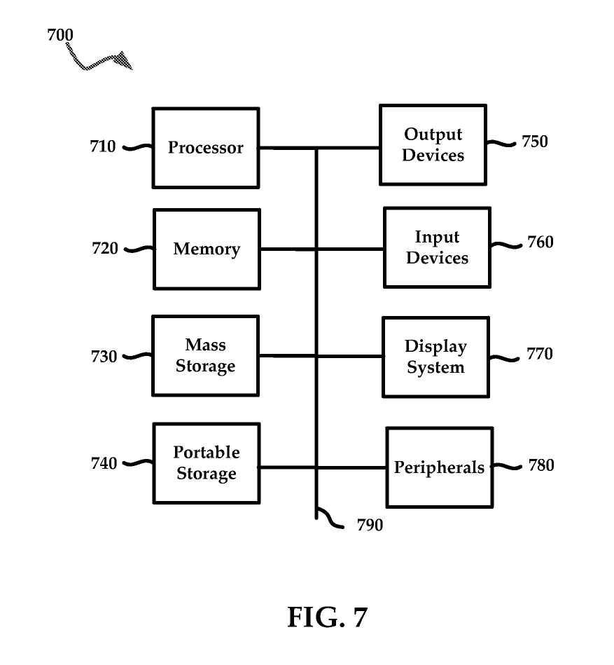

In some instances, the broadcast system 110 may comprise a trend analysis system 110A. The trend analysis system 110A may comprise a processor for executing instructions stored in memory of a computing device. The computing device may be a constituent part of the trend analysis system 110A and may comprise a server or other suitable computing device that may be utilized to deliver broadcast content or a programming guide to the end user computing system 105. Additional details regarding an exemplary computing system are found in FIG. 7, and corresponding disclosure provided below.

According to some embodiments, the trend analysis system 110A comprises a user interface module 125, a recommendation engine 130, and an alert module 135. It is noteworthy that the executable instructions may include additional modules, engines, or components, and still fall within the scope of the present technology. As used herein, the term “module” may also refer to any of an application-specific integrated circuit (“ASIC”), an electronic circuit, a processor (shared, dedicated, or group) that executes one or more software or firmware programs, a combinational logic circuit, and/or other suitable components that provide the described functionality. In some embodiments, individual modules may include separately configured web servers. Also, the modules may be provisioned within a cloud.

In some instances, the trend analysis system 110A may be implemented within a cloud-based computing environment. In general, a cloud-based computing environment is a resource that typically combines the computational power of a large model of processors and/or that combines the storage capacity of a large model of computer memories or storage devices. For example, systems that provide a cloud resource may be utilized exclusively by their owners, such as Google™ or Yahoo!™; or such systems may be accessible to outside users who deploy applications within the computing infrastructure to obtain the benefit of large computational or storage resources.

The cloud may be formed, for example, by a network of web servers, with each web server (or at least a plurality thereof) providing processor and/or storage resources. These servers may manage workloads provided by multiple users (e.g., cloud resource consumers or other users). Typically, each user places workload demands upon the cloud that vary in real-time, sometimes dramatically. The nature and extent of these variations typically depend on the type of business associated with the user.

The user interface module 125 may be executed to generate various graphical user interfaces. These graphical user interfaces may comprise a visual representation of a ranked list of broadcast content, such as television shows, which have been ranked, not in canonical numerical order relative to channel number (in some embodiments), but according to trend data. According to some embodiments, the visual representation may comprise a program guide that comprises a matrix of programs arranged according to channel and time, but ranked hierarchically according to trend data, for example. Exemplary user interfaces generated by the user interface module 125 will be described in greater detail below.

Prior to generating and providing program guides or other suitable user interfaces, the recommendation engine 130 may be executed to rank the broadcast content according to trend data. Generally described, the recommendation engine 130 may receive a broadcast content data set that includes, for each instance of broadcasted content, a content description (e.g., name, cast, ratings, synopsis, and so forth). The broadcast content data set may also comprise channel information and program time, which may include a start time, an end time, and program duration. Thus, broadcast content may be generally arranged into a matrix according to channel number and program time, as with conventional program guides. Advantageously, broadcast content may be dynamically ordered (or reordered over time) by the recommendation engine 130 such that the broadcast content is displayed in a ranked format according to trend data.

In general, trend data may comprise any one or more of personal trend data, social network data, content consumption data, search engine data, program viewership data, box office data, content ratings, rental data, sales data, and combinations thereof. The following sections outline specific exemplary types of trend data that may be utilized by the recommendation engine 130 to dynamically recorder broadcast content.

Personalized Trend Data

In some embodiments, the program guide may display a personalized and prioritized listing of broadcast content based on each individual user's viewing behaviors over time. For a given time slot on the program guide, the order of channels may be re-prioritized to display the broadcast content (shows, movies, channels and other content elements) in a list ranked according to what is most likely to be of interest to the end user. This ranked list of broadcast content may be derived from the calculations of the recommendation engine 130, which may adapt the program guide to reflect historical viewing behaviors of the end user to understand the types of programs they are interested in and at what times they want to watch them.

Social Activity Data

Social network activity contains a wealth of trend data, which is based on user interaction and user generated content. Prioritization of listings within the program guide may be based on both aggregate behavior determined from a social graph, as well as observed behavior of trends in a local network of the end user, such as “Friends,” “Followers,” or other similar social connections. This concept also extends to the use of content consumption services, such as Netflix®, Amazon®, iTunes®, etc., where trends may similarly be identified based on user activity, queue ordering, ratings, and the like. The recommendation engine 130 may dynamically re-order displayed listings based on the trending concepts such as, for example, those listed below, or a calculated trend based a combination of the following trending concepts.

Trend data may be obtained or derived from social networks and content services. For example, messages such as wall posts regarding broadcast content topics (e.g., TV Shows, Movies, Products, and the like) may be collected for trend data. Additionally, social network messages may comprise a sentiment, which can be extracted using Natural Language Processing (NLP) to derive sentiment specific trends (e.g., most liked programs, most hated programs, most requested programs, etc.). Trending data may also obtained from keywords or phrases included in social network messages.

Preference data from social networks such as Facebook® may be determined by examining “Likes” or other indications of content approval or disapproval. Additionally, trend data may be determined from aggregate number of “Check-ins” at a location or event. That is, various social and/or content consumption services use the concept of ‘checking in’ to venues or watching a television show or some other equivalent user behavior. In some instances, “Shares” may be used to calculate trend data. Shares may be evaluated for data about broadcast content or items that have been shared over social networks and/or content consumption services.

Social networks and consumption services that allow end users to ‘Rate’ actions can be used to identify trends based on overall demonstrated user affinity, as reflected by submitted rating scores. Additionally, recommendations provided via social networks and/or content consumption services, such as explicit recommendation of programming or items to others within the service, may also be utilized by the recommendation engine 130 to determine trend data.

According to various embodiments, the recommendation engine 130 may utilize trend data that includes data that tracks which shows users are watching. Thus, trend data can be derived based on watched programming. Additionally, queuing data may also be used for content consumption services, which support programming/rental queues. Thus, trend data can be derived based on queue position and queue addition.

In accordance with the present disclosure, trend data may be obtained from other social networking platforms such as Twitter®, Blogs, and Microblogs. Social networking data from these platforms that may comprise topic popularity, where trend data can be derived based on what people are discussing on these services. These trends may be based on a quantity of topic mentions via hashtags, topic mentions as derived by NLP, or other text processing methods that would be known to one of ordinary skill in the art. Additionally, an overall sentiment of messages pertaining particular topics, as well as “Retweets” or re-posting of previous microblog posts may also be utilized.

Movie Box Office Reports

In some embodiments, the recommendation engine 130 may use movie box office reports in order to prioritize the hierarchy of content listings for movies that appear in a cable system, whether scheduled as “linear TV” or as video on demand (VOD). The popularity trend of movies can be derived from box office returns and the breakdown of box office by region and major city (DMA) may be used as an input into the TV listing user interface to create a hierarchical listing of local movie popularity trends.

Content Ratings

Websites or other publications, such as the content providers 120, that offer access to an aggregation of content ratings, whether they are derived from professional critics (e.g. www.metacritic.com, or www.rottentomatoes.com which assign a score to content based on the average ratings received from professional critics) or are user generated, may be used by the recommendation engine 130 to create a trend of quality or popularity to influence the hierarchy of listings of broadcast content in an exemplary program guide.

Advertising Spending Reports

According to some embodiments, the recommendation engine 130 may also determine trend data from advertising spending reports that detail the number of dollars spent by advertisers to sponsor or advertise their products in association with an item of content (e.g., TV show). These spending reports may be utilized as an indication of the trends of viewership, popularity, and/or influence of that broadcast content. Additionally, if the time that the advertisement airs and the amount of money spent on that advertisement are disclosed, the program guide can be affected to display content popularity trends based on ad spending reports in real time. For instance, advertisements are sold in particular slots around a program, and within these slots, advertisements may be either the first advertisement, the second, third, and so forth. These slots have values associated therewith and may be used to derive a trend that can be used by the recommendation engine 130 to influence the hierarchy of listings of content within the program guide.

Search Engine Data

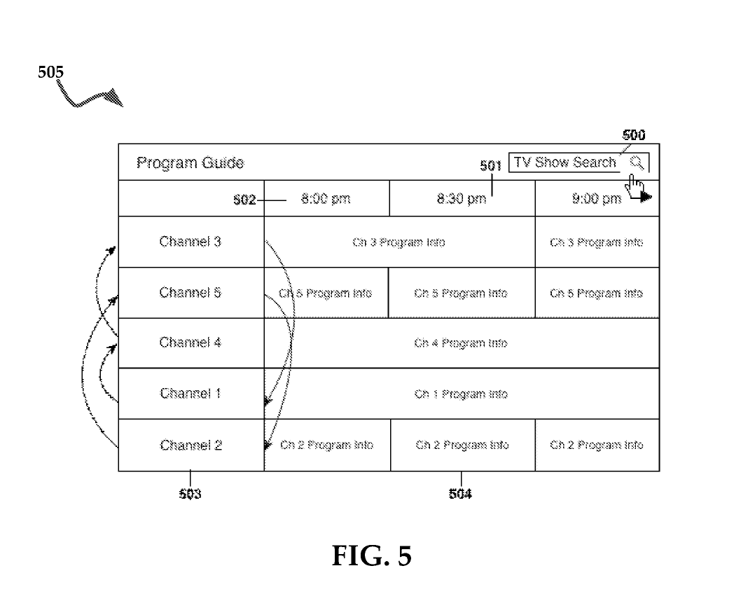

In some embodiments, the recommendation engine 130 may also utilize an aggregate number of searches for items of content or programming on search engines (e.g., Google, Bing, etc.) as an indication of current popularity trends. These search engine data sets can be used by the recommendation engine 130 to create a hierarchy of program and channel listings. Additionally, search engine volume for a particular item of content within the search functionality of the program guide may also be used by the recommendation engine 130 to derive a trend of popularity which affects the user interface. (See exemplary FIG. 5)

Rental and Purchase Sales Data

The consumption trends of content that is available for rent or for purchase either digitally or physically (e.g., Amazon Streaming, Blockbuster retail stores, etc.) may be used by the recommendation engine 130 to influence the hierarchy of content within a program guide.

Audience Viewership Such as Nielson Ratings®

Television programming viewership statistics and associated demographic data may be measured and reported by companies. This data may be used by the recommendation engine 130 to derive a trend of audience viewership to understand the total viewership of programs, which may be used to influence the hierarchy of content within the program guide. Additionally, the demographic audience composition data for television programming can deliver a secondary layer of trend data (e.g., popularity of a show within a certain age group or in a certain market) that can influence the hierarchy of content within the program guide.

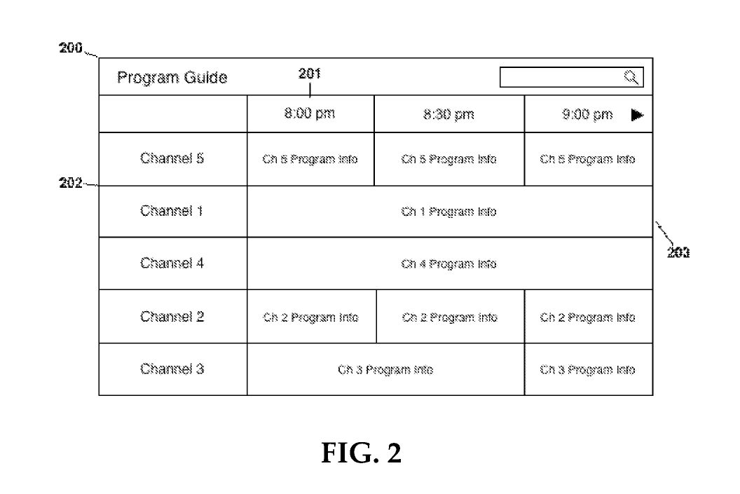

FIG. 2 is a graphical user interface in the form of a default trend user interface (e.g., program guide), hereinafter referred to as “program guide 200.” The program guide 200 is shown as including a current time slot 201 for which programming (e.g., broadcast content) is prioritized and/or broadcasted. It is contemplated that the program guide 200 may comprise a prioritized list of channels 202 for which broadcast content is shown. The program guide may also comprise a schedule 203 for current and upcoming programming based on the prioritization of the broadcast content using trend data. Rather than canonical hierarchy for displaying broadcast content (e.g., Channel 1-5), the recommendation engine 130 has reorganized the ranking of broadcast content such that the program guide 200 has reordered hierarchical list of Channel 5, Channel 1, Channel 4, Channel 2 and Channel 3, in vertical top-down order.

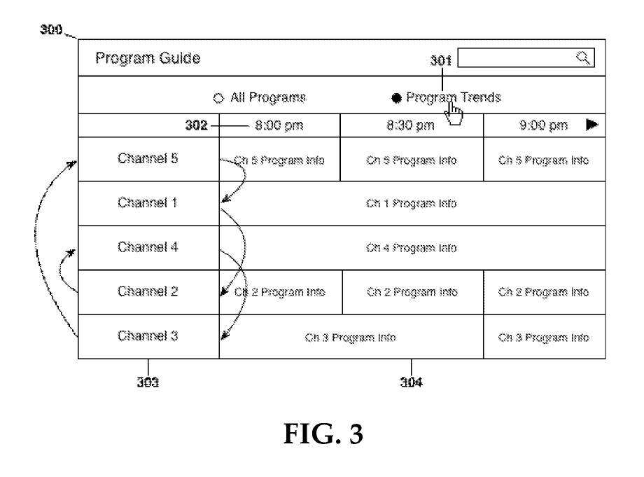

FIG. 3 illustrates a user selectable trend relative to a default trend user interface, hereinafter “program guide 300.” The program guide 300 of FIG. 3 is substantially similar to the program guide 200 of FIG. 2. FIG. 3 illustrates a selectable UI element 301, such as a radio button that allows the end user to select trend based sorting. It is noteworthy that the program guide 300 may comprise a current time slot 302 for which programming is prioritized and/or broadcasted. A prioritized list of channels 303 for broadcast content is shown as well as a scheduling 304 for current and upcoming broadcast content based on hierarchical reordering of broadcast content based upon trend data. The arrows show channel reorganization within the program guide based upon the trend data.

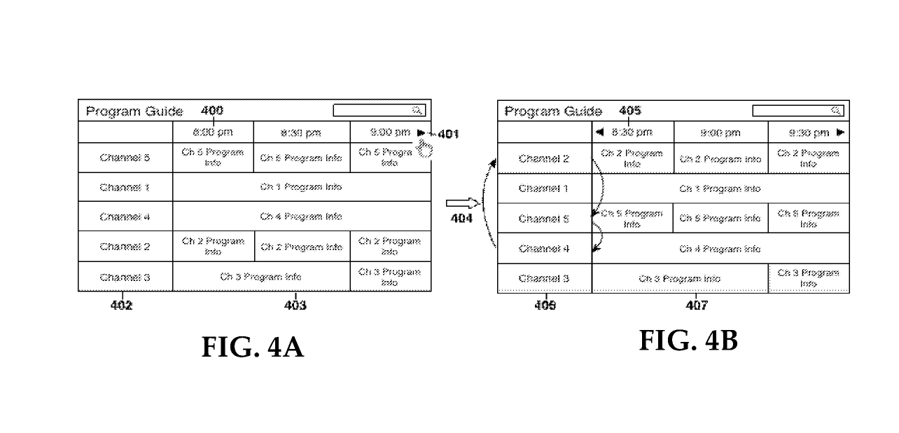

FIGS. 4A and 4B collectively illustrate trend reprioritization across time slots of a program guide. In FIG. 4A, a first program guide 400 may comprise a current time slot for which broadcast content is prioritized/broadcasted. In some exemplary embodiments, the first program guide 400 may comprise a UI element 401 that allows a user to navigate TV listings forward to future time slots. Additionally, the first program guide 400 may comprise a prioritized list of channels 402 that comprise a plurality of broadcast content. The first program guide 400 may also comprise scheduling 403 for current and upcoming broadcast content based on prioritized list. In some instances, the first program guide 400 may also comprise a channel list 404, which has been reprioritized after a time slot is advanced to reflect trends based on a currently selected time slot, as shown in FIG. 4B.

More specifically, FIG. 4B illustrates an exemplary selected time slot 405 (advanced in time one half hour) for which programming is prioritized/broadcasted. The newly reprioritized channel list 406 is shown, as well as a new scheduling 407 for current and upcoming programming based on the new prioritization, which is also trend-based.

FIG. 5 illustrates internal search feature 500 for another exemplary program guide 505. In some embodiments, the search feature 500 comprises a text input box that allows the end user to enter natural language queries therein. A future time slot 501 for which programming may be prioritized/broadcasted is shown, as well as a current time slot 502 for which programming is prioritized/broadcasted. In some cases, the program guide 505 may comprise a reprioritized channel listing 503 which is based on any of the aforementioned trending schemes. It is envisioned that a re-ordered program listing 504 which is based on current channel order may also be shown.

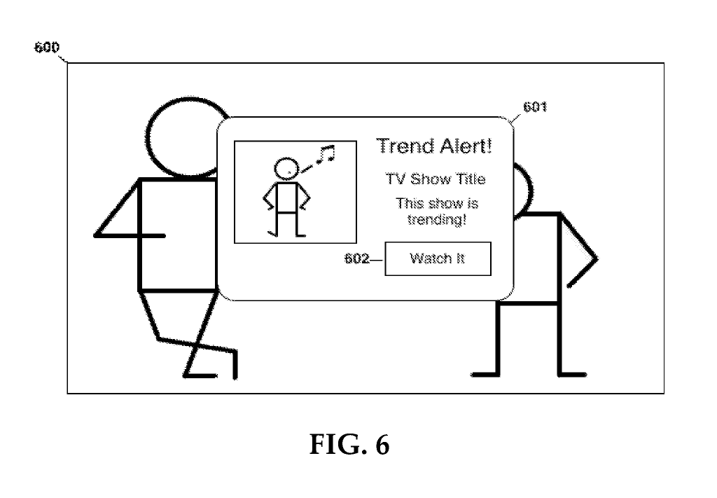

FIG. 6 illustrates an alert message 601 provided via a graphical user interface. The alert message 601 may comprise a dynamic alert indicating trending programming and associated content details. In some embodiments, the alert message 601 may comprise a click to watch element 602 which provides direct access for a user to change currently shown programming to a trending program, or a list of trending programs. While alert messages have been described as being delivered or incorporated into a user interface, it will be understood that alert messages may comprise short message service (SMS) messages, e-mail messages, or other mechanisms that allow for the communication of hierarchically ranked broadcast content.

While the graphical user interfaces of FIG. 2-5 illustrate various program guides that include ranked lists of broadcast content which have been arranged hierarchically according to trend data, one of ordinary skill in the art will appreciate that the ranked list of broadcast content may be output in any suitable visual, audio, or multimedia format. Therefore, the exemplary matrix format used herein is not limiting and any hierarchical ranked listing of broadcast content based upon trend data may likewise be utilized in accordance with the present technology.

Additionally, the hierarchical ranked listing of broadcast content may, in some instances, not be used in the context of a program guide. Ranked lists may be stored in records within a database. These records may be used to create reports that are utilized by broadcasters, advertisers, content authors, or other parties who may benefit from knowing how various types of trending data affect the ranking or ordering of broadcast content. Additionally, the trending data may be applied to broadcast content after the broadcasting of such content, to provide additional ranking information. That is, the ranking of broadcast content need not be executed contemporaneously with the broadcasting of the content.

While some of the above-described embodiments of the present technology contemplate the generation of program guides at the broadcast system 110 or the trend analysis system 110A, it will be understood that the broadcast system 110 and/or the trend analysis system 110A may provide a ranked list used to populate the program guide to the end user computing system 105. In some instances, such as with set-top boxes, the end user computing system 105 may generate the program guide at the end user computing system 105, populating the program guide with the received ranked list data.

FIG. 7 illustrates an exemplary computing system 700 that may be used to implement an embodiment of the present systems and methods. The system 700 of FIG. 7 may be implemented in the contexts of the likes of computing systems, networks, servers, or combinations thereof. The computing system 700 of FIG. 7 includes one or more processors 710 and main memory 720. Main memory 720 stores, in part, instructions and data for execution by processor 710. Main memory 720 may store the executable code when in operation. The system 700 of FIG. 7 further includes a mass storage device 730, portable storage medium drive(s) 740, output devices 750, user input devices 760, a display system 770, and peripheral devices 780.

The components shown in FIG. 7 are depicted as being connected via a single bus 790. The components may be connected through one or more data transport means. Processor unit 710 and main memory 720 may be connected via a local microprocessor bus, and the mass storage device 730, peripheral device(s) 780, portable storage device 740, and display system 770 may be connected via one or more input/output (I/O) buses.

Mass storage device 730, which may be implemented with a magnetic disk drive or an optical disk drive, is a non-volatile storage device for storing data and instructions for use by processor unit 710. Mass storage device 730 may store the system software for implementing embodiments of the present invention for purposes of loading that software into main memory 720.

Portable storage device 740 operates in conjunction with a portable non-volatile storage medium, such as a floppy disk, compact disk, digital video disc, or USB storage device, to input and output data and code to and from the computer system 700 of FIG. 7. The system software for implementing embodiments of the present invention may be stored on such a portable medium and input to the computer system 700 via the portable storage device 740.

User input devices 760 provide a portion of a user interface. User input devices 760 may include an alphanumeric keypad, such as a keyboard, for inputting alpha-numeric and other information, or a pointing device, such as a mouse, a trackball, stylus, or cursor direction keys. User input devices 760 may also include a touchscreen. Additional user input devices 760 may comprise, but are not limited to, devices such as speech recognition systems, facial recognition systems, motion-based input systems, gesture-based systems, and so forth. Additionally, the system 700 as shown in FIG. 7 includes output devices 750. Suitable output devices include speakers, printers, network interfaces, and monitors.

Display system 770 may include a liquid crystal display (LCD) or other suitable display device. Display system 770 receives textual and graphical information, and processes the information for output to the display device.

Peripherals device(s) 780 may include any type of computer support device to add additional functionality to the computer system. Peripheral device(s) 780 may include a modem or a router.

The components provided in the computer system 700 of FIG. 7 are those typically found in computer systems that may be suitable for use with embodiments of the present invention and are intended to represent a broad category of such computer components that are well known in the art. Thus, the computer system 700 of FIG. 7 may be a personal computer, hand held computing system, telephone, mobile computing system, workstation, server, minicomputer, mainframe computer, or any other computing system. The computer may also include different bus configurations, networked platforms, multi-processor platforms, etc. Various operating systems may be used including Unix, Linux, Windows, Mac OS, Palm OS, Android, iOS (known as iPhone OS before June 2010), QNX, and other suitable operating systems.

It is noteworthy that any hardware platform suitable for performing the processing described herein is suitable for use with the systems and methods provided herein. Computer-readable storage media refer to any medium or media that participate in providing instructions to a central processing unit (CPU), a processor, a microcontroller, or the like. Such media may take forms including, but not limited to, non-volatile and volatile media such as optical or magnetic disks and dynamic memory, respectively. Common forms of computer-readable storage media include a floppy disk, a flexible disk, a hard disk, magnetic tape, any other magnetic storage medium, a CD-ROM ROM disk, digital video disk (DVD), any other optical storage medium, RAM, PROM, EPROM, a FLASHEPROM, any other memory chip or cartridge.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. Exemplary embodiments were chosen and described in order to best explain the principles of the present technology and its practical application, and to enable others of ordinary skill in the art to understand the invention for various embodiments with various modifications as are suited to the particular use contemplated.

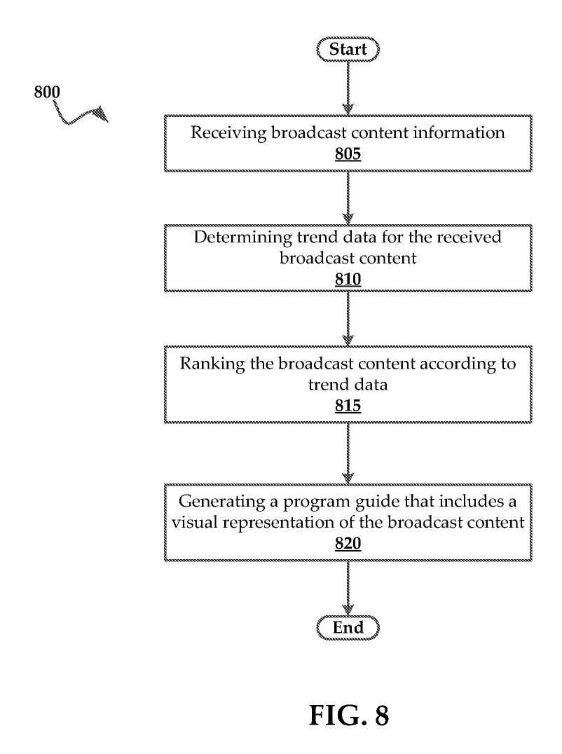

FIG. 8 is a flowchart of an exemplary method 800 for generating a program guide. The method 800 may comprise a step 805 of receiving broadcast content information. More specifically, for each instance of broadcasted content, a content description (e.g., name, cast, ratings, synopsis, and so forth) may be determined. The broadcast content data set may also comprise channel information and program time, which may include a start time, an end time, and program duration.

Additionally, the method 800 may comprise a step 810 of determining trend data for the received broadcast content. The term “determining” may be understood to include, receiving, obtaining, capturing, calculating, evaluating, and so forth. Again, the trend data may comprise one or more of the many exemplary types of trend data described above.

Next, the method may comprise a step 815 of ranking the broadcast content according to trend data. The ranking may comprise a hierarchical ranking of the broadcast content. For example, broadcast content, which is typically ranked in canonical channel order may be rearranged, reorganized, or reordered in a format that allows channels to be displayed in a non-canonical numerical order (e.g., according to trend data).

The method may also comprise a step 820 of generating a program guide that includes a visual representation of the broadcast content. Again, the visual representation may comprise a hierarchically ranking of the broadcast content according to the trend data.

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While various embodiments have been described above, it should be understood that they have been presented by way of example only, and not limitation. The descriptions are not intended to limit the scope of the technology to the particular forms set forth herein. Thus, the breadth and scope of a preferred embodiment should not be limited by any of the above-described exemplary embodiments. It should be understood that the above description is illustrative and not restrictive. To the contrary, the present descriptions are intended to cover such alternatives, modifications, and equivalents as may be included within the spirit and scope of the technology as defined by the appended claims and otherwise appreciated by one of ordinary skill in the art. The scope of the technology should, therefore, be determined not with reference to the above description, but instead should be determined with reference to the appended claims along with their full scope of equivalents.

What is claimed is:

1. A method, comprising:
ranking, via a trend analysis system, broadcast content according to trend data; and
generating a program guide that includes a visual representation of the broadcast content, which is hierarchically ranked according to the trend data.

2. The method according to claim 1, wherein trend data comprises personal trend data that represents personal preferences of an end user and wherein the generating is accomplished via a user interface module.

3. The method according to claim 2, wherein the personal trend data comprises historical viewing behaviors for the end user.

4. The method according to claim 1, wherein trend data comprises social network data obtained from a social graph.

5. The method according to claim 1, wherein trend data comprises social network data obtained from one or more social networks.

6. The method according to claim 5, wherein social network data comprises social network activity of an end user and social network activity of one or more social connections of the end user.

7. The method according to claim 6, wherein social network activity comprises one or more of messages, likes, check-ins, content sharing, content ratings, content recommendations, and combinations thereof.

8. The method according to claim 1, wherein trend data comprises social network data obtained from one or more social networks, the social network data comprising a sentiment associated with a message placed on a social network.

9. The method according to claim 1, wherein trend data comprises social network data obtained from one or more social networks, the social network data comprising one or more of a quantity of mentions, a quantity of hashtags, a quantity of messages, or combinations thereof that represent content popularity.

10. The method according to claim 1, wherein trend data comprises content consumption data for an end user.

11. The method according to claim 1, wherein trend data comprises box office data for movies.

12. The method according to claim 1, wherein trend data comprises one or more of content ratings and sales data for the broadcast content, the content ratings comprise movie ratings obtained from movie critic sources.

13. The method according to claim 1, wherein trend data comprises search engine data for the broadcast content.

14. The method according to claim 1, wherein trend data comprises program viewership data and associated demographic data, wherein ranking comprises ranking the broadcast content according to both the viewership data and its associated demographic data, relative to an age of an end user.

15. The method according to claim 1, further comprising providing a trend alert message to an end user, the trend alert indicating that trend data for broadcasting content meets or exceeds a threshold trending value.

16. A system, comprising:
at least one computing device comprising a memory that includes executable instructions and a processor executing the instructions, the instructions comprising:
a recommendation engine that ranks broadcast content according to trend data; and
a user interface module that generates a program guide that includes a visual representation of the ranked broadcast content.

17. The system according to claim 16, wherein trend data comprises one or more of personal trend data, social network data, content consumption data, search engine data, program viewership data, and combinations thereof.

18. The system according to claim 16, further comprising an alert module that provides a trend alert message to an end user, the trend alert indicating that trend data for broadcasting content meets or exceeds a threshold trending value.

19. The system according to claim 16, wherein the at least one computing device is selected from a list consisting of a set-top box, a personal computer, a tablet, a mobile device, or a server.

20. A method, comprising broadcasting a program guide, the program guide comprising a dynamic ordering of broadcast content based upon trend data, the trend data comprising one or more of personal trend data, social network data, content consumption data, search engine data, program viewership data, box office data, content ratings, rental data, sales data, and combinations thereof.
